(19) United States
(12) Patent Application Publication
(10) Pub. No.: US 2005/0091241 A1
(43) Pub. Date: Apr. 28, 2005

(54) Method for organizing analytic data for incremental knowledge management using graphs

(75) Inventors: W. Nathaniel Mills III, Coventry, CT (US); Karen A. Witting, Croton-on-Hudson, NY (US)

Correspondence Address: Rafael Perez-Pineiro;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 10/975,969

(22) Filed: Oct. 28, 2004

Related U.S. Application Data
(60) Provisional application No. 60/515,014, filed on Oct. 28, 2003.

(51) Int. Cl. G06F 7/00

(52) U.S. Cl. 707/100

(57) ABSTRACT

A method is disclosed for organizing data structure, data and metadata in a portable, self contained manner able to be acted upon by centralized or distributed applications. In cases where distributed applications alter data, metadata, or data structure relating them or describing potential data structure, these alterations may be returned to a central manager to update a database for persistence and transactional integrity of this information.

### BACKGROUND OF THE INVENTION

1. Field of the Invention

The invention generally relates to the data processing field. More specifically, the invention relates to the field of systems management or other fields where applications generate, manipulate, and associate metadata and data.

2. Description of the Related Art

Typical databases require definition of the structure of their data (e.g., schema) and require modification to this structure in order to accommodate storage and retrieval of new types of data or new associations within the data. This requires applications that access these databases to be modified as well to reflect these changes, creating opportunity for errors.

In fluid situations where the data structure changes frequently, such as in a research and development environment, or diagnostic and prognostic analysis, managing these changes in data structure is both time consuming and costly. Analysis of data may generate metadata. Metadata may be defined as descriptors summarizing some derived or other attribute of the data. Metadata associations with other metadata or data may be sparse, requiring careful data structure design, time managing empty data references, or wasted space. Analysis of data often relies on knowledge of the data structure and may be used to alter or enhance the data structure by generating new metadata or data and associations therein. Automating the analysis of metadata and data and its structure is advantageous because it may allow newly discovered data relationships or metadata generation methods to be applied to existing databases.

Extending the knowledge of the metadata and data, and their interrelationships through the use of automated analytics may be referred to as incremental knowledge management. Incremental knowledge management allows the retroactive application of newly discovered ways of interpreting information to previously accumulated information. The current art, however, requires manual manipulation and coordination of the data structures in a database and applications in anticipation of running automated analysis. In addition, there are often situations where distributed data processing requires metadata, data and the data structure to be extracted from the database, analyzed, and then returned to update the database.

Therefore, there is a need in the art for system and methods that (1) separate the organization of the data from the database, thereby eliminating database administration requirements to address changes in data structure and allowing the application to manage the data structure; (2) allow dynamic data structure changes without requiring underlying changes in the database; (3) allow the data structure to be queried to retrieve a subset of associated metadata, data and the data structure; (4) allow this subset to be distributed across networks for remote and/or distributed processing; and (5) allow this subset to be merged back into the original metadata, data and data structure (e.g., to apply updates generated externally).

### SUMMARY OF THE INVENTION

In view of the foregoing, the present invention provides a method of organizing data structure, data, and metadata in a portable, self contained manner capable of being acted upon by distributed applications and returned to a central manager to update the database for persistence and transactional integrity. The invention may use directed, self referencing hypergraph (SRHG) techniques to maintain an ontology of data concepts and relationships used to associate these concepts with one another. In one embodiment of the present invention, the ontology is a graph defining a data structure. An algebra is used to describe how the relations may be navigated and how different ontology's may be merged. The invention also uses self referencing hypergraph techniques to organize and manage data and metadata according to the ontology. The invention supports queries of these graphs to return subsets of the graphs which are also SRHG's. These subsets may be sent to distributed applications for analysis, processing, and alteration, and later returned to be merged back into their parent so it can update itself to reflect these alterations. In one embodiment of the present invention, the parent graph (e.g., the main graph from which subsets can be retrieved and altered) is backed by a database that provides persistence and transactional integrity.

### BRIEF DESCRIPTION OF THE DRAWINGS

The invention will be better understood from the following detailed description with reference to the drawings, in which:

FIG. 1 illustrates a chart describing elements used in one embodiment of the method for ontology management of the present invention;

FIG. 2 illustrates a chart describing elements used in one embodiment of the method for analysis data management of the present invention; and

FIG. 3 illustrates a representative hardware environment in which the methods of the present invention may be implemented.

### DETAILED DESCRIPTION OF THE PREFERRED EMBODIMENTS OF THE INVENTION

The present invention includes a method for using self referencing hypergraph organization of data, metadata and the data structure relating them to provide incremental knowledge management in centralized or distributed applications.

The present invention includes a method for creating an ontology based on a self referencing hypergraph. The invention also includes a method for creating an analysis data container that incorporates the ontology as well as a graph of related data and/or metadata. That analysis data container may then be used to exploit data relationships and alter the data structure containing the analyzed data based on the data exploitation.

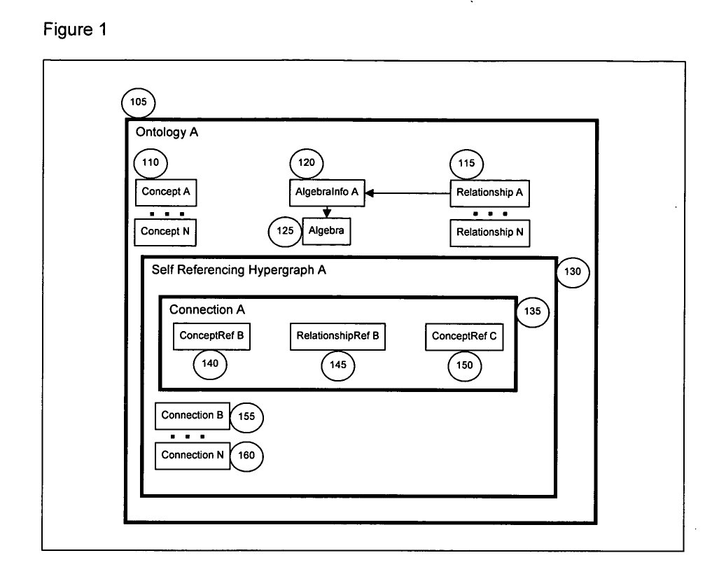

As shown in FIG. 1, an Ontology 105 contains information about the Concepts 110 that define the type of data or metadata that will be managed, the Relationships 115 that are used to relate Concepts with each other, and a Self Referencing Hypergraph 130 including a collection of allowable Connections 135.

In FIG. 1, Connection A 135 includes a pair of references to Concepts, ConceptRef B 140 and ConceptRef C 150, connected by a reference to a RelationshipRef B 145. Relationships may be associated with Algebra Information. For example, in FIG. 1 the Relationship A 115 is related to AlgebraInfo A 120 that describes how the relationships are navigated (e.g., is the relationship hierarchical or peer to peer) and the set of Algebra Information are merged to form an Algebra 125 used to allow one Ontology to be merged with other Ontology. If the Relationship is defined to support this in its algebra information, a Connection can be formed between one Concept and several other Concepts. For example, a concept of “family” may relate multiple concepts of “people” using the Relationship “HasFamilyMember”.

The Ontology's Self Referencing Hypergraph 130, as illustrated, includes a collection of Connections: Connection A 135, Connection B 155, and Connection N 160. The Self Referencing Hypergraph 130 may define the allowable Relationships between Concepts within the Ontology. In one embodiment of the present invention, the Ontology may be created by using the following method:

1. Define the Concepts to be used by the Ontology

2. Define the Relationships to be used by the Ontology

a. Define the Relationship

b. Define the Algebra Information for the Relationship

3. Define the allowable Connections between Concepts using Relationships

4. Repeat steps 1 through 3 as needed.

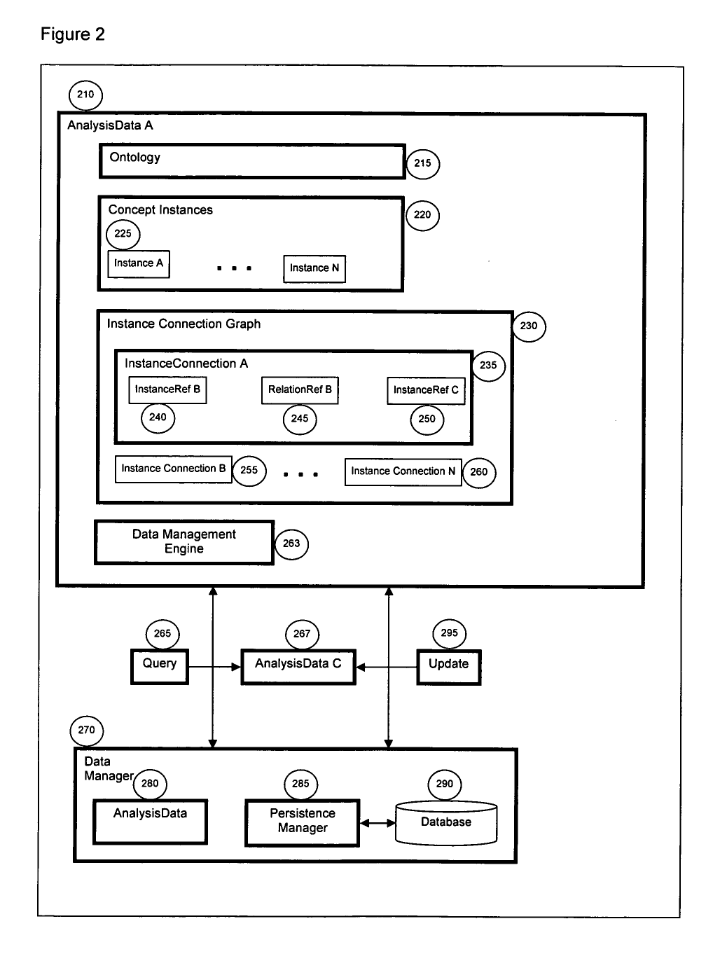

FIG. 2 shows components used in the method for analysis data management in accordance with one embodiment of the present invention. The Analysis Data A 210 may be defined as a portable container for data, metadata and data structure that can be queried to retrieve information and can be updated. The Analysis Data may include:

1. an Ontology 215 which maintains allowable data structure;

2. a Concept Instances 220 container that can hold instantiations of one or more of the Concepts in the Ontology 215. The Concept Instances 220 may include one or more Instances of Concepts that hold or organize data or metadata, for example, Instance A 225.

3. an Instance Connection Graph 230 representing the actual data structure of the Analysis Data container may include:

a. a collection of zero or more Instance Connections (e.g., Instance Connection A 235). The collection may in turn include:

i. two or more references to Instances (e.g., InstanceRef B 240, and InstanceRef C 250) connected by a reference to a Relationship (e.g., RelationRef B 245) in the Ontology 215.

4. a Data Management Engine 263 that interprets and acts upon queries (e.g., Query 265) to retrieve data, metadata, data structure, and/or another Analysis Data container from the Analysis Data, or to update data, metadata and/or data structure in the Analysis Data as defined in an Update 295 or in another Analysis Data container.

The Analysis Data container may be self contained and is able to operate detached from the database which persists the data, thereby allowing applications to freely run in a distributed, networked environment without being tied back to the database (e.g., through JDBC, ODBC or other remote method calls). Analysis Data may be serialized for transmission across networks and/or written to disk for safe storage and later retrieval. A Query 265 may be formed providing selection filters for data, metadata, and data structure and can issue to an Analysis Data (e.g., AnalysisData C 267) to retrieve a collection of data, metadata and/or data structure contained in the Analysis Data container, or another Analysis Data container containing a subset of the Analysis Data that was queried. A Query 265 can also be issued to a Data Manager 270. The Data Manager may include:

1. Analysis Data 280

2. a Persistence Manager 285 used to reflect updates in the Analysis Data 280 to the Database 290 and/or to retrieve or update data or metadata referenced in the Analysis Data 290 from the Database 290.

3. a Database where data, metadata and data structure referenced in Analysis Data 280 are maintained for persistence and transactional integrity.

The following method may be used to create the Analysis Data:

1. Create an Ontology (as described above) to hold the allowable data structure.

2. Create Concept Instances by instantiating Concepts to hold data or metadata.

3. Create Instance Connections by associating multiple references to Concept Instances using a reference to a Relationship. In one embodiment of the invention, the collection of these Instance Connections constitutes the Instance Connection Graph.

4. Repeat steps 2 and 3 as needed.

In one embodiment of the present invention, the following method may be used for deleting the concepts in the ontology:

1. Remove any Concept Instances instantiated from the Concept from the Analysis Data containing the Ontology.

a. Remove any Instance Connections that reference the Concept Instance to be removed.

2. Remove any Connections in the Ontology that reference the Concept.

3. If and only if there are no Concept Instances instantiated from a Concept in the Analysis Data containing the Ontology, and the Ontology doesn't have any Connections referencing the Concept, delete the Concept from the Ontology.

4. Repeat steps 1 through 3 as needed.

In one embodiment of the present invention, the following method may be used for deleting the relationships in the ontology:

1. Remove any Instance Connections in Analysis Data containing the Ontology that reference the Relationship to be deleted.

2. Remove any Connections in the Ontology that reference the Relationship to be deleted.

3. If and only if there are no Instance Connections or Connections that reference the Relationship, delete the Relationship from the Ontology.

a. If and only if there are no longer any Relationship's referencing the Algebra Information associated with the Relationship to be deleted, delete the Algebra Information.

4. Repeat steps 1 through 3 as needed.

In one embodiment of the present invention, the following method may be used for deleting instance information (e.g., data or metadata) managed in Analysis Data:

1. Remove any Instance Connections that contain the reference to the Instance containing the data or metadata.

2. If and only if all Instance Connections containing references to the Instance containing the data or metadata have been removed, delete the Instance containing the data or metadata from the Concept Instances.

3. Repeat steps 1 through 2 as needed.

In one embodiment of the present invention, deleting instance connections managed in the Analysis Data may be performed by deleting the Instance Connection matching the identity of the desired Instance Connection from the Instance Connection Graph. An alternative to creating Analysis Data from scratch is to use a Query to retrieve Analysis Data from another Analysis Data container or from a Data Manager.

In one embodiment of the invention, the Querying Analysis Data may be implemented as follows:

1. Form the selection criteria for comparing Concept Instances and/or Instance Connections including any combination of the following”

a. comparators for Concepts

b. comparators for Relationships

c. comparators for Instances instantiated from Concepts in the result set from applying a above to the Ontology

d. comparators for Instance Connections referencing Instances in the result set from applying c above to the Concept Instances, and referencing Relationships in the result set from applying b above to the Ontology.

2. Specify the type of information to be returned (e.g., Analysis Data or collection of data, metadata, and/or data structure).

3. Submit the Query to Analysis Data or to the Data Manager for processing.

4. Repeat steps 1 through 3 as needed.

In one embodiment of the invention, Updating Analysis Data could use the following method:

1. Create or delete Analysis Data Ontology Concepts and/or Relationships, Instances or Instance Connections.

2. Submit the modified Analysis Data for Update to another Analysis Data container or to a Data Manager.

a. If the updates submitted create contradictions in the data structure of the receiving Analysis Data and the receiving Analysis Data performs the updates that do not create contradictions and returns status of the updates performed with explanations why not all updates were performed. An example of a contradiction is when a Concept succesfully deleted from the submitted Analysis Data because it was no longer referenced, but the receiving Analysis Data container has other references to that container, unknown to the submitted Analysis Data. At an Instance and Instance Connection level, the effect of the update is still reflected in the receiving Analysis Data. Retaining Concepts and Relationships in the Ontology will occur until the update has removed all references to these objects in the receiving Analysis Data.

b. if the Instance being updated references additional data stored in the database, the data manager removes the additional data if and only if no other references to this data exist.

c. if the update is submitted to a data manager, the changes made to its Analysis Data may be reflected by the Persistence Manager 285 in the Database 290.

The Data Manager 270 may be initialized by having the Persistence Manager 285 read the Database 290 to create the Analysis Data 280 according to the previously described method.

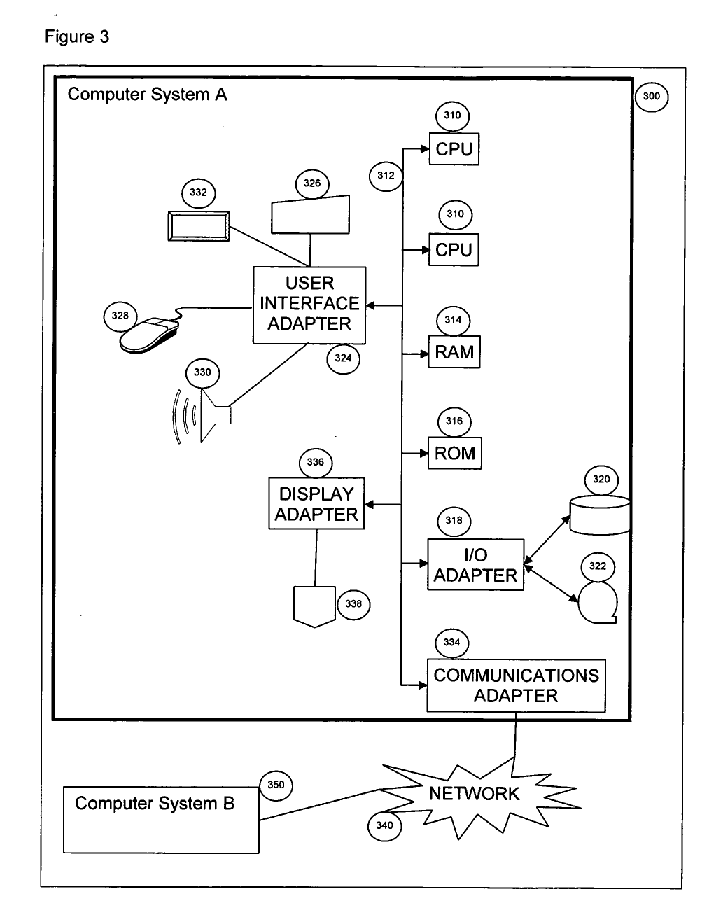

A representative hardware environment (e.g., computer system) for practicing the present invention is depicted in FIG. 3, which illustrates a typical hardware configuration of an information handling/computer system in accordance with the present invention, having at least one processor or central processing unit (CPU) 310. The CPUs 310 are interconnected via system bus 312 to random access memory (RAM) 314, read-only memory (ROM) 316, an input/output (I/O) adapter 318 for connecting peripheral devices, such as disk units 320 and tape drives 322, to bus 312, user interface adapter 324 for connecting keyboard 326, mouse 328, speaker 330, microphone 332, and/or other user interface devices such as a touch screen device (not shown) to bus 312, communication adapter 334 for connecting the information handling system to a data processing network 340, and display adapter 336 for connecting bus 312 to display device 338. A program storage device readable by the disk or tape units is used to load the instructions, which operate the invention, which is loaded onto the computer system 300. The invention may also be used on multiple computer systems to support distributed applications. In this case once computer system 300 may run the data manager and another computer system 350 may run software using the invention to perform analysis on data retrieved from the other computer system 300 across the network 340. Any updates performed on computer system 350 to the data could be returned to the other computer system 300 to be updated by the data manager in its analysis data.

While the invention has been described in terms of a single embodiment, those skilled in the art will recognize that the invention can be practiced with modification within the spirit and scope of the appended claims. Further, it is noted that, Applicants' intent is to encompass equivalents of all claim elements, even if amended later during prosecution.

1. A method for incremental knowledge management in centralized or distributed applications comprising:
creating an ontology defining an allowable data structure;
creating an analysis data container aware of the ontology to manage data from the data structure, metadata derived from said data, and interrelations between said data and metadata;
associating the analysis data container with a database for persistence and transactional integrity; and
adding to the analysis data container new data, metadata, and interrelations between them according to what is allowed by the ontology.

2. The method of claim 1, further comprising:
querying the analysis data container to retrieve at least one of:
a subset of data,
metadata,
data and metadata interrelationships, and
the ontology defining data structure;
processing a result of the querying to update at least one of:
data,
metadata,
data and metadata interrelationships, and
the ontology defining data structure;
inputting the result into a second analysis data container; and
updating the first analysis data container with changes contained in the second analysis data container.

3. The method of claim 1, wherein the step of creating the ontology comprises:
defining data concepts to be used by the ontology;
defining data relationships to be used by the ontology; and
defining allowable connections between the data concepts by using data relationships.

4. The method of claim 3, wherein the step of defining the data relationships comprise defining an algebra information for the data relationships.

5. The method of claim 3, wherein the step of defining allowable connections comprises defining a self referencing hypergraph of interconnected data concept references using references to data relationships.

6. The method of claim 1, wherein said ontology comprises a map to define said data structure.

7. The method of claim 3, wherein said algebra information describes how the relationships are navigated and how said ontology may be merged with at least a second ontology.

8. The method of claim 1, wherein the step of creating said analysis data container comprises:
creating data concept instances by instantiating data concepts to hold data or metadata; and
creating instance connections by associating multiple references to the data concept instances using a reference to a relationship.

9. The method of claim 2, wherein the step of updating the first analysis data container comprises deleting data relationships in the ontology, the step of deleting the relationships in the ontology:
removing any instance connections in the analysis data container that reference the relationship to be deleted;
removing any connections in the ontology that reference the relationship to be deleted;
if there are no instance connections or connections that reference the relationship to be deleted, delete that relationship from the ontology; and
if there are no longer any relationships referencing the algebra associated with the relationship to be deleted, delete the algebra information.

10. The method of claim 2, wherein the step creating said first analysis data container comprises creating data concept instances by instantiating data concepts to hold data or metadata; and the step of updating the first analysis data container comprises deleting data or metadata, the step of deleting data or metadata comprising:
removing any instance connections that contain a reference to an instance containing the data or metadata; and
if all instance connections containing references to the instance containing the data or metadata have been removed, deleting the instance containing the data or metadata from the data concept instances.

11. The method of claim 2, wherein the querying step comprises:
forming a selection criteria for comparing concept instances or instance connections including any combination of the following:
comparators for concepts;
comparators for relationships;
comparators for instances instantiated from concepts in the result set from applying the comparators for concepts to the ontology; and
comparators for instance connections referencing instances in a result set from applying said comparators for instances instantiated from concepts to the concept instances, and referencing relationships in a result set from applying said comparators for relationships to the ontology; and
specifying a type of information to be returned by the query.

12. The method of claim 1, wherein specifying the type of information comprises specifying at least one of the following:
analysis data;
metadata; and
data structure.

13. The method of claim 2, wherein the step of updating the first analysis data container comprises:
modifying the first analysis data container by creating or deleting concepts, relationships, instances or instance Connections in the ontology; and
submitting the modified first analysis data container for update into the second analysis data container or into a data manager.
